(19) United States
(12) Patent Application Publication
(10) Pub. No.: US 2025/0276363 A1
(43) Pub. Date: Sep. 4, 2025

(54) METAL POWDER AND METHOD FOR PRODUCING SAME

(71) Applicant: JFE MINERAL & ALLOY COMPANY, LTD., Tokyo (JP)

(72) Inventors: Kan SAITO, Tokyo (JP); Hiroshi YAMANE, Tokyo (JP); Takanori MAKISE, Tokyo (JP); Atsushi OKADA, Tokyo (JP)

(73) Assignee: JFE MINERAL & ALLOY COMPANY, LTD., Tokyo (JP)

(21) Appl. No.: 18/855,773

(22) PCT Filed: Jun. 6, 2023
(86) PCT No.: PCT/JP2023/020947

§ 371 Date: Oct. 10, 2024

(30) Foreign Application Priority Data
Jun. 13, 2022 (JP) 2022-094863

(51) Int. Cl. B22F 1/054; B22F 9/28

(52) U.S. Cl. CPC B22F 1/054; B22F 9/28; B22F 2301/15; B22F 2304/05; B22F 2998/10; B22F 2999/00

(57) ABSTRACT

A metal powder in which 99.5 mass % or more of the metal component is Ni, the ratio of metal particles having the ratio S/D_{PV} of the minor axis S of the metal particles to the equal volume sphere equivalent diameter D_{PV} of the metal particles is 0.92 or less and the ratio D_{PV}/D_{PV50} of the equal volume sphere equivalent diameter D_{PV} to the volume-based median diameter D_{PV50} is 1.8 or more is 1.0 vol % or less, and the volume-based median diameter D_{PV50} of the metal particles is 0.08 to 0.35 μm. Furthermore, the S content per a specific surface area of 1 m²/g is preferably 70 to 600 ppm, and similarly, the O content is preferably 1200 to 7000 ppm.

### TECHNICAL FIELD

The present invention relates to a metal powder and a method for producing the same, and more particularly to a fine metal powder having a nickel content of 99.5 mass % or more in a metal component suitable for producing a multilayer ceramic capacitor, and a method for producing the same.

### BACKGROUND ART

Multilayer ceramic capacitors (Hereinafter, it is also referred to as “MLCC”) are required to be small in size and high in capacitance, and are required to have electrodes and dielectric layers reduced in thickness. The thinnest multilayer ceramic capacitor is required to have nickel electrode layers and dielectric layers each having a thickness of 0.5 μm or less. As these layer thicknesses become thinner, problems in terms of quality that were not apparent with conventional thick layer thicknesses become more conspicuous. An example thereof is occurrence of a short circuit between ceramic phases due to oversintering of an electrode. The oversintering is caused by coarse particles in the electrode raw material powder, and classification treatment is generally performed to remove the coarse particles.

For example, Patent Literature 1 discloses, for the purpose of reducing the amount of coarse particles exceeding 1 μm to prevent a short circuit due to metal particles between capacitors, and to obtain a high-capacity MLCC, that nickel powder produced by a gas phase hydrogen reduction method is slurried, and then classified by a centrifuge to remove the coarse particles, thereby obtaining a nickel ultrafine powder in which the number of particles having an average particle size of primary particles of 0.05 to 0.3 μm and a primary particle size of 1 μm or more is 50 ppm or less of the total number of particles, and the number of particles having a particle size of 0.6 times or less the average particle size in the primary particles is 10% or less of the total number of particles.

In addition, Patent Literature 2 discloses, for the purpose of improving a decrease in capacitance of a capacitor due to thinning of an internal electrode, a metal powder in which among connected particles formed by connecting metal particles, a ratio of the connected particles having an aspect ratio of 1.2 or more, a circularity of 0.675 or less, and a major axis of 3 times or more a number 50% diameter of the metal powder contained in the metal powder is 500 ppm or less on a number basis, a ratio of a crystallite diameter to the number 50% diameter of the metal powder is 0.50 or more, and a metal constituting the metal particles is nickel. It is described that by performing the reduction reaction step and the cooling step under specific treatment conditions, generation of connected particles to be coarse particles is suppressed to obtain the metal powder.

### CITATION LIST

### Patent Literature

Patent Literature 1: JP 4409989 B2
Patent Literature 2: JP 6553313 B2

### SUMMARY OF INVENTION

### Technical Problem

However, there is a problem that, although the decrease in the capacitor capacitance can be suppressed by reducing the number of connected particles, the suppression of crack occurrence and the improvement in breakdown voltage, which are indexes of reliability in the quality of the MLCC, cannot be sufficiently solved.

An object of the present invention is to solve the problems of the prior art, and to provide a metal powder suitable for an internal electrode for producing an MLCC excellent in reliability with high yield even when the electrode layer and the dielectric layer are thinned, and a method for producing the same.

### Solution to Problem

In order to achieve the above object, the present inventors have intensively studied powder characteristics of metal powders and reliability of the MLCC. First, in order to obtain a highly reliable MLCC with a high yield, classification treatment for removing coarse particles and connected particles in metal particles is required. However, it has been found that some capsule-shaped coarse connected particles that impair the reliability of the MLCC remain also on the fine powder side after the classification treatment only by performing the classification treatment. From this finding, it has been considered that in order to eliminate the capsule-shaped coarse connected particles that cannot be removed by the classification treatment, it is necessary to reduce the capsule-shaped coarse connected particles in the powder generated in the stage of the CVD reaction which is a stage before the classification treatment.

Based on such findings, the present invention has been completed by further studying a CVD reaction method for suppressing generation of some capsule-shaped coarse connected particles that are not removed by the classification described above. That is, the gist of the present invention is as follows.

[1] A metal powder in which 99.5% or more of a metal component is nickel on a mass basis, and the balance is an inevitable impurity, wherein
when a maximum major axis of a metal particle constituting the metal powder is a major axis (L) and a diagonal width of the major axis (L) is a minor axis (S), a ratio of metal particles having a ratio (S/D_{PV}) of the minor axis (S) to an equal volume sphere equivalent diameter (D_{PV}) of the metal particles of 0.92 or less and a ratio (D_{PV}/D_{PV50}) of the equal volume sphere equivalent diameter (D_{PV}) to a volume-based median diameter (D_{PV50}) of 1.8 or more is 1.0% or less on a volume basis, and
the volume-based median diameter (D_{PV50}) of the metal particle is 0.08 μm to 0.35 μm.

[2] The metal powder according to the [1], wherein the S (sulfur) content of the metal powder per specific surface area of 1 m²/g is 70 ppm to 600 ppm.

[3] The metal powder according to the [1] or [2], wherein an O (oxygen) content per a specific surface area of 1 m²/g of the metal powder is 1200 ppm to 7000 ppm.

[4] A method for producing a metal powder, comprising:
a vaporization step of evaporating or vaporizing a metal compound to form a metal compound gas;
a reaction step of reacting the metal compound gas with a reducing gas to produce metal powder; and
a cooling step of cooling a generated metal powder,
wherein a gas cooled in the cooling step is prevented from flowing back to the reaction step, and
in the cooling step, a gas for cooling in an amount of 0.5 times molar amount to 5.0 times molar amount of a total amount of an inert gas and the reducing gas required for the reaction is used.

[5] The method for producing a metal powder according to the [4], wherein
the metal powder contains nickel as 99.5% or more of a metal component on a mass basis and an inevitable impurity as a balance, and
when a maximum major axis of a metal particle constituting the metal powder is a major axis (L) and a diagonal width of the major axis (L) is a minor axis (S), a ratio of metal particles having a ratio (S/D_{PV}) of the minor axis (S) to an equal volume sphere equivalent diameter (D_{PV}) of the metal particles of 0.92 or less and a ratio (D_{PV}/D_{PV50}) of the equal volume sphere equivalent diameter (D_{PV}) to a volume-based median diameter (D_{PV50}) of 1.8 or more is 1.0% or less on a volume basis, and
the volume-based median diameter (D_{PV50}) of the metal particle is 0.08 μm to 0.35 μm.

[6] The method for producing a metal powder according to the [5], wherein the S (sulfur) content of the metal powder per specific surface area of 1 m²/g is 70 ppm to 600 ppm.

[7] The method for producing a metal powder according to the [5] or [6], wherein an O (oxygen) content per a specific surface area of 1 m²/g of the metal powder is 1200 ppm to 7000 ppm.

### Advantageous Effects of Invention

According to the present invention, it is possible to provide a metal powder suitable for an internal electrode for producing an MLCC excellent in reliability with a high yield even when the electrode layer and the dielectric layer are thinned, and a method for producing the metal powder, and an industrially remarkable effect is exhibited.

### BRIEF DESCRIPTION OF DRAWINGS

FIG. 1 is a schematic cross-sectional view illustrating an outline of an apparatus for producing a metal powder according to the present invention.

FIG. 2 is a schematic view showing an outline of capsule-shaped connected particles.

FIG. 3 is an image of a SEM photograph of capsule-shaped connected particles.

### DESCRIPTION OF EMBODIMENTS

The powder characteristics of the metal powders and the reliability of the MLCC studied by the present inventors will be described in more detail.

### [Powder Characteristics of Metal Powder]

Powder characteristics affecting the indexes of reliability of the MLCC were examined. First, the metal powder is generally easily sintered when the curvature of the particle surface is large, but is hardly sintered in the case of spherical particles. However, it is considered that in the capsule-shaped connected particle 10 as in the schematic view shown in FIG. 2 and the SEM photographic image shown in FIG. 3, the curvature of the end part is large for a large volume, and sintering easily proceeds. Therefore, there is a concern that oversintering is likely to occur and it is likely to become a core of oversintering that impairs the reliability of the MLCC.

As shown in FIG. 2, when the maximum major axis of the particle measured by image analysis is a major axis (L) and the diagonal width orthogonal to the maximum major axis is a minor axis (S), the capsule-shaped connected particle 10 has a spherical part (hemisphere) having the minor axis (S) as a diameter at both ends of the particle. It has a capsule-like shape that can be well approximated by considering it as a cylindrical part having a length of “L−S” with its minor axis (S) as the diameter at the central part.

As a result of intensive studies by the present inventors, it has been found that the capsule-shaped connected particles have a certain volume, but spherical parts at both ends have a hemispherical shape having a minor axis as a diameter, and thus have a high curvature and are easily sintered. Furthermore, the present inventors have found that the ratio (S/D_{PV}) of the equal volume sphere equivalent diameter (D_{PV}) and the minor axis (S) that determines the curvature of both end parts of the connected particles when the shape is spherical with the same volume is an index of the likelihood of forming a core of oversintering. Then, it was revealed that the presence of coarse metal particles is related to the reliability of the MLCC.

The metal powder according to the present invention has been defined on the basis of the above examination results, and embodiments thereof will be described below.

### [Metal Powder]

The metal powder according to the present invention includes the following requirements.
[A] Metal powder in which 99.5% or more of a metal component is nickel on a mass basis, and the balance is an inevitable impurity.

Among the metal particles constituting the [B] metal powder, the ratio of the metal particles specified in the following [b1] and [b2] is 1.0% or less on a volume basis.
[b1] When the maximum major axis of the metal particles is a major axis (L) and the diagonal width of the major axis (L) is a minor axis (S), the ratio (S/D_{PV}) of the minor axis (S) to the equal volume sphere equivalent diameter (D_{PV}) of the metal particles is 0.92 or less.
[b2] The ratio (D_{PV}/D_{PV50}) of the equal volume sphere equivalent diameter (D_{PV}) to the volume-based median diameter (D_{PV50}) is 1.8 or more.
[C] The volume-based median diameter (D_{PV50}) of the metal particle is 0.08 μm to 0.35 μm.

Furthermore, preferably,
[D] The S (sulfur) content per specific surface area of 1 m²/g of the metal powder is 70 ppm to 600 ppm.
[E] The O (oxygen) content per a specific surface area of 1 m²/g of the metal powder is 1200 ppm to 7000 ppm.

### [Chemical Component of Metal Powder]

First, with respect to the chemical component of the metal powder, which is a requirement of [A], 99.5% of the metal component on a mass basis is nickel, and the balance is an inevitable impurity. This inevitable impurity is a metal component inevitably mixed from a raw material or an apparatus, and specific examples thereof include Fe, Cr, Co, Cu, Si, Ag, Mo, W, Ta, Nb, Pt, Al, and Zr. If the total content of these inevitable impurities is less than 0.5% on a mass basis, it is acceptable.

### [Shape and Distribution of Metal Particle]

Next, requirements [B (b1+b2)] and [C] regarding the metal particle constituting the metal powder will be described.

As a method for specifying the shape and size of powder such as metal particles, an object such as powder is generally measured by an image analysis method. In this case, the absolute maximum length of the object is defined as the maximum major axis, but in the present invention, the maximum major axis is defined as the major axis (L) of the metal particle. Next, the shortest distance between two straight lines when a figure (object image) is sandwiched between the two straight lines parallel to the absolute maximum length is referred to as a diagonal width, and in the present invention, the diagonal width is defined as the minor axis (S) of the metal particle.

The equal volume sphere equivalent diameter of the metal particles corresponds to the diameter in the case of spherical particle having the same volume. For example, when the volume of a certain particle is V, the equal volume sphere equivalent diameter (D_{PV}) is obtained by the following equation (1).

$${D}_{PV} = {( V \div Π \times 6 )}^{1 / 3} \qquad ( 1 )$$

As described above, an object of the present invention is to provide metal powder (Hereinafter, it is also referred to as “metal ultrafine powder”) having an average particle size of 1 μm or less in which coarse connected particles among metal particles constituting the metal powder are reduced and variations in particle size are suppressed. That is, the requirement of [b1 and b2] of the present invention defines the shape of the metal particles as a result of also excluding some coarse connected particles that are not excluded in the prior art.

First, in order to exclude coarse particles, particles having a ratio (S/D_{PV}) of a minor axis (S) of a metal particle to an equal volume sphere equivalent diameter (D_{PV}) of 0.92 or less, which is a requirement of [b1], should be reduced.

The ratio (S/D_{PV}) of the minor axis (S) to the equal volume sphere equivalent diameter (D_{PV}) of the metal particle means that when the value is 1.00, the minor axis of the metal particle is the same as the equal volume sphere equivalent diameter, and the metal particle is spherical. That the ratio is smaller than 1.00 means that the particles are not spherical but elliptical in shape, and forming a connected particle. An object of the present invention is to reduce capsule-shaped connected particles that have been difficult to eliminate by the above-described prior art, and is intended for particles having the above ratio (S/D_{PV}) of 0.92 or less.

The following requirement [b2] is an index for suppressing the variation in particle size distribution, and is defined using the equal volume sphere equivalent diameter (D_{PV}). The contents thereof are to reduce particles having a ratio (D_{PV}/D_{PV50}) of the equal volume sphere equivalent diameter (D_{PV}) to the volume-based median diameter (D_{PV50}) of 1.8 or more.

The volume-based median diameter (D_{PV50}) is a volume-based median diameter of an equal volume sphere equivalent diameter (D_{PV}), and is a diameter at which the equal volume sphere equivalent diameter on a volume basis is a cumulative 50%. The fact that there are many particles having a ratio (D_{PV}/D_{PV50}) of the equal volume sphere equivalent diameter (D_{PV}) to its median diameter (D_{PV50}) of 1.8 or more means that the particle size distribution is broad and there are many coarse particles.

According to the requirement [B] that the ratio of the metal particles targeted in the above [b1] and [b2] is 1.0% or less on a volume basis, metal particles having a narrow particle size distribution in which the presence of large particles is reduced are collected, and a metal powder in which the target coarse connected particles are reduced is obtained.

### [Volume-Based Median Diameter of Equal Volume Sphere Equivalent Diameter]

The requirement of [C] is that the volume-based median diameter (D_{PV50}) of the equal volume sphere equivalent diameter of the metal particles is 0.08 μm to 0.35 μm.

When the particle size is too small, sintering easily proceeds, and therefore in order to maintain the quality of the MLCC, the volume-based median diameter (D_{PV50}) is defined as a particle size of 0.08 μm or more. In recent MLCC products required to be small and large in capacity, the thickness of the electrode is required to be reduced, and therefore the particle size is defined to be 0.35 μm or less. The thickness is preferably 0.10 μm to 0.30 μm.

### [S (Sulfur) Content]

Further, as the requirement of [D], the S (sulfur) content per a specific surface area of 1 m²/g of the metal powder is preferably 70 ppm to 600 ppm. This is because a small amount of S (sulfur) has an effect of increasing the sintering onset temperature in the debinding step during firing of the MLCC. When the S (sulfur) content per specific surface area of 1 m²/g of the metal powder is less than 70 ppm, oversintering is likely to occur. In addition, even if the S (sulfur) content is too large, a sulfide having a low melting point is formed, which causes oversintering during firing of the MLCC, and thus the S (sulfur) content is preferably 600 ppm or less. More preferably, the content is 100 ppm to 450 ppm per a specific surface area of 1 m²/g of the metal powder, which is a range in which a target content can be stably obtained.

### [O (Oxygen) Content]

As the requirement of [E], the O (oxygen) content per specific surface area of 1 m²/g of the metal powder is preferably 1200 ppm to 7000 ppm. When the O (oxygen) content is more than 7000 ppm, the proportion occupied by the oxide increases, and thus the amount of nickel metal per specific surface area of 1 m²/g decreases, so that the thermal shrinkage amount of the internal electrode of the MLCC increases, and a crack is likely to occur. Therefore, the O (oxygen) content per a specific surface area of 1 m²/g of the metal powder is preferably 7000 ppm or less. In addition, when the O (oxygen) content is less than 1200 ppm, the sintering rate of nickel metal becomes too high, which causes oversintering, which is not preferable. More preferably, the oxygen concentration is 2500 ppm to 4500 ppm per a specific surface area of 1 m²/g of the metal powder because the target oxygen concentration can be stably and reproducibly obtained.

### [Method for Producing Metal Powder]

It is important to reduce the connected particles described above, and a method for producing a metal powder therefor will be described.

A growth method synthesized from atoms, molecules, ions, and the like is often used for the metal ultrafine powder having an average particle size of 1 μm or less, and among them, the metal ultrafine powder can be produced by a known gas phase method, liquid phase method, or the like. Examples of the gas phase method include a gas phase chemical reaction method (It is also referred to as a “CVD method”) in which a gasified metal chloride and a reducing gas are reacted, a spray pyrolysis method in which a metal compound or a solution is sprayed to a gas phase and thermally decomposed, and an evaporation method (It is also referred to as a “PVD method”) in which a metal is evaporated at high temperature and rapidly cooled and condensed. Since the metal ultrafine powder produced by the gas phase method has higher crystallinity and a higher sintering onset temperature than those produced by the liquid phase method, it is known that the metal ultrafine powder is less likely to be oversintered during firing for producing the MLCC, and is suitable when the internal electrode layer is formed to be thin.

In a gas phase chemical reaction method for producing a nickel ultrafine powder, a reduction reaction of a nickel alkoxide or a reduction reaction of a nickel halide is used. Among them, nickel chloride is easily available and it is easy to remove impurities. Therefore, as an industrial scale production method, a method of reacting nickel chloride vapor with a reducing gas such as hydrogen is preferable. The industrial scale means that products of 10 kg or more can be produced per day as an example.

When the metal ultrafine powder is produced by a so-called gas phase method such as the CVD method or the PVD method described above, connected particles in which primary particles are thermally fused are generated and coarsened. Therefore, since metal powders usually have a certain degree of particle size distribution, these coarse particles are removed by classification treatment. In the prior arts so far, the mixing of coarse particles is prevented by performing the classification operation in which the partial classification point (classification point at which coarse powder is 50% and fine powder is 50%) is equivalent to the volume cumulative median diameter, but some capsule-shaped coarse connected particles are not removed even in such classification operation.

For classification on an industrial scale, a gravity classifier, a cyclone classifier, a centrifugal classifier, or the like is used, but irregularly-shaped particles receive larger resistance from a fluid than spherical particles, and therefore coarse particles are mixed into the fine particle side. Therefore, the connected particles are not removed by classification, and remain on the fine particle side. For this reason, it is important to reduce the number of connected particles in the metal powder before classification.

Therefore, as a method of not generating such coarse connected particles, for example, Patent Literature 2 described above describes that the generation rate of the connected particles can be generally lowered by cooling after particle generation and growth. However, a large amount of cooling gas is required to perform rapid cooling at a certain level or more, and therefore, in an actual apparatus on an industrial scale, when a large amount of cooling gas is used, the cooling gas flows back to a region where the particles grow, and the particles are promoted to be united in a reaction field, so that the number of connected particles increases.

From the above examination results, the present inventors have found that it is effective to perform a treatment for preventing the cooling gas from flowing back when the gas in the reaction field is sent to the cooling unit in order to suppress the generation of the connected particles.

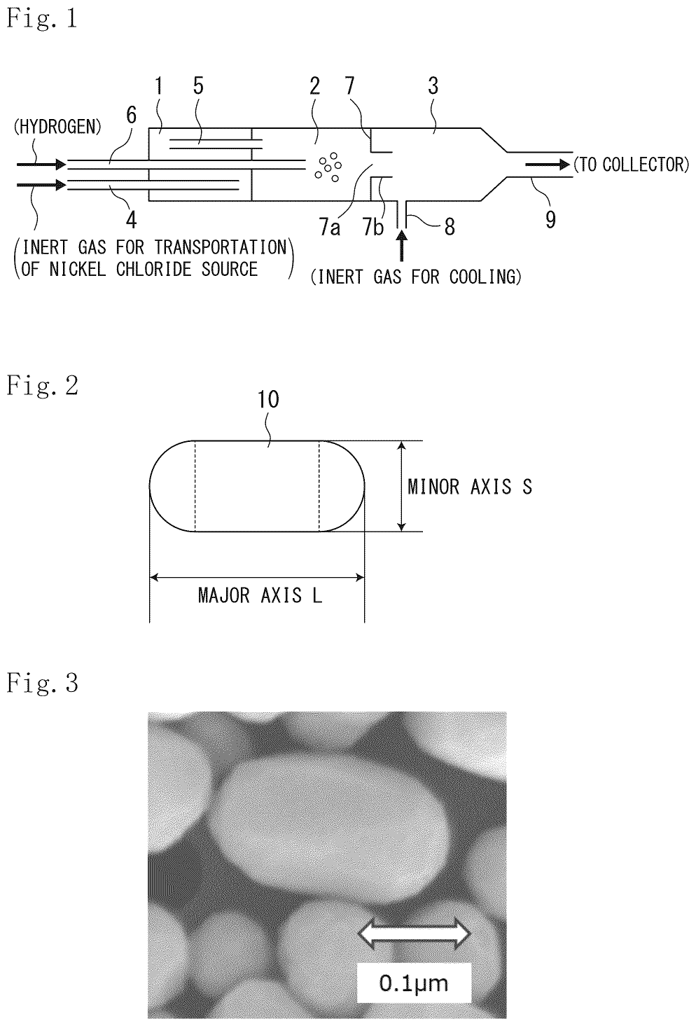

As one embodiment of the method for producing a nickel ultrafine powder according to the present invention, a production method using a CVD method will be described as an example. FIG. 1 is an example (Hereinafter, it is also referred to as the “present apparatus”) of an apparatus for producing nickel ultrafine powder suitable for the production method of the present invention.

The present apparatus has a cylindrical shape, and in the case of an industrial scale, the diameter is preferably 100 mm or more in consideration of adhesion of powder to the inside of the apparatus, and is preferably 2000 mm or less in consideration of ease of installation and handleability.

The present apparatus is continuously provided with a vaporizing unit 1 that vaporizes a nickel chloride source, a reaction unit 2 that reacts nickel chloride vapor with a reducing gas to precipitate nickel ultrafine powder, and a cooling unit 3 that cools the generated nickel ultrafine powder using an inert gas as a medium for cooling. By continuously performing the reaction in which the nickel ultrafine powder is precipitated from the supply of the nickel chloride vapor and the subsequent cooling and collection, and providing the orifice 7 between the reaction unit 2 and the cooling unit 3, generation of a large vortex in the apparatus due to the flowback is suppressed, and the nickel ultrafine powder having a narrow particle size distribution and few coarse particles can be obtained.

Specific steps of the producing method will be described in order.

### (1) Vaporizing Step

First, a nickel chloride source for obtaining nickel chloride vapor is introduced from the raw material introduction pipe 4 into the vaporizing unit 1 by a non-reactive inert gas such as nitrogen gas for transporting nickel halide powder such as nickel chloride. The nickel chloride source is not limited thereto, but it is preferable to use anhydrous solid nickel chloride which does not liquefy and sublimates when heated, and it is more preferable to use fine particles of 3 mm or less for easy vaporization. In addition to the above, as the nickel chloride source, metal nickel may be introduced together with chlorine gas. At that time, nickel metal reacts with the chloride gas in the vaporizing unit 1 to form nickel chloride vapor, but in order to facilitate the reaction, the metal nickel is preferably a fine powder having an average particle size of 10 μm or less.

In addition, in order to contain S (sulfur), it is preferable to mix a sulfide or a sulfate with nickel chloride as a raw material, or to mix a sulfur source such as a sulfite gas with nitrogen gas for transportation.

Around vaporizing unit 1, there is a heat source (not shown) that applies heat necessary for vaporization, and a suitable temperature is maintained. As the heat source, a known heat source can be used, and an electric furnace or the like that can be easily installed in equipment is preferable. When nickel chloride is used, the temperature in the apparatus is preferably maintained at 980° C. or higher at which the partial pressure is 0.9 or higher in order to easily vaporize the nickel chloride. In addition, when the temperature of the nickel chloride gas becomes too high, the nickel chloride gas rapidly reacts in the next reaction unit 2 to easily form coarse particles, and thus the temperature is preferably 1300° C. or lower. The temperature is more preferably 1050° C. to 1200° C.

### (2) Reaction Step

The nickel chloride vapor obtained in the vaporizing unit 1 passes through the introduction pipe 5 and is introduced into the reaction unit 2 together with the inert gas for transportation. Further, hydrogen gas is introduced into the reaction unit 2 by the hydrogen nozzle 6. There is a heat source (not shown) around the reaction unit 2, and a suitable temperature is maintained. As the nickel chloride heat source, a known electric furnace or the like can be used. Nickel chloride vapor is reduced by hydrogen gas at a certain temperature or higher, and nickel ultrafine powder is generated in a gas. However, in order to sufficiently reduce nickel chloride vapor, the temperature in the apparatus is preferably maintained at 900° C. or higher. In addition, similarly to the vaporizing unit 1, it is preferable to set the temperature to 1300° C. or lower so as not to be too high. The temperature is more preferably 1000° C. to 1150° C.

In addition, the amount of inert gas for transportation needs to be appropriate in order to control the generated particle size. In the CVD method, since the residence time in the reaction unit 2 has the largest influence on the particle size, it is preferable to control the gas amount in order to obtain nickel ultrafine powder having a target particle size. Since the required amount of gas varies depending on the diameter and length of the apparatus to be used, it is necessary to adjust the gas in a timely manner in order to obtain a target particle size. Furthermore, if there is a temporal variation in the amount of gas, the particle size distribution of the recovered powder spreads, and thus the amount of gas is preferably constant. For the control of the gas amount, a known gas control apparatus can be used, but it is preferable to use a mass flow controller or the like capable of supplying a certain amount even when the pressure loss of the apparatus or the pipe fluctuates.

### (3) Cooling Step

The generated nickel ultrafine powder is conveyed to an inert gas for transportation, passes through the central part of the orifice 7, and is introduced into the cooling unit 3. The orifice 7 is provided to prevent flowback of gas from the cooling unit 3 to the reaction unit 2. In the cooling unit 3, the high-temperature nickel ultrafine powder is cooled by the inert gas for cooling introduced from the cooling gas nozzle 8. When the temperature is kept high, the nickel ultrafine powders are fused to each other, and coarse particles or capsule-shaped particles are generated, so that it is preferable to rapidly cool the nickel ultrafine powders. The inert gas for cooling may be non-reactive, but it is industrially preferable to use an inexpensive gas such as nitrogen gas.

In addition, as a result of examining the amount of cooling gas, the amount of cooling gas is preferably 0.5 times molar amount or more of the total amount of reaction gases including the inert gas for transportation and the reducing gas. When the molar amount is less than 0.5 times molar amount, the particles are not cooled well, and many capsule-shaped particles are generated. The amount is more preferably 1.0 times molar amount or more, still more preferably 3.0 times molar amount or more the total amount of the reaction gas. In addition, if the amount exceeds 5.0 times molar amount of the total amount of the reaction gas, the pressure loss of the entire apparatus becomes too large, and the continuous operability is deteriorated due to adhesion to the pipeline. Therefore, the amount is preferably 5.0 times molar amount or less the total amount of the reaction gas. The continuous operability is an index of whether the apparatus can be operated without being blocked due to adhesion, and is evaluated by the operation time until the apparatus is blocked.

Further, as a result of intensive studies on the structure of the orifice 7 provided for preventing the flowback of the cooling gas from the cooling unit 3 to the reaction unit 2, it has been found that the opening area in the opening 7a at the center of the orifice 7 is preferably 25% to 75%, and more preferably 36% to 66% of the cross-sectional area of the reaction unit 2. This is because when the opening area of the opening 7a of the orifice 7 is too large, the effect of suppressing the flowback is weak, and when the opening area is too small, the opening is blocked by adhesion of metal powder.

Furthermore, it is preferable to provide a cylinder 7b of a guide for rectification on the cooling unit 3 side of the opening 7a, and the length of the cylinder 7b is preferably 10% or more of the diameter of the opening 7a. There is no upper limit to the length of the cylinder 7b, but if the length is too long, it is predicted that the cylinder 7b is closed due to adhesion of metal powder, and thus it is preferable to set the length to an appropriate length.

### (4) After Cooling Step

The cooled nickel ultrafine powder is discharged from the exhaust pipe 9 provided on the downstream side by the reaction gas and the cooling gas, carried to a collector, not shown in the figure, and recovered.

Since a trace amount of nickel chloride may remain in the nickel ultrafine powder generated by the CVD method, the nickel ultrafine powder is washed. As a solvent for washing, any solvent may be used as long as nickel chloride is dissolved, but since nickel chloride is easily dissolved in water, it is preferable to use pure water or distilled water without impurities.

Further, after washing, drying is performed using a known drying apparatus such as a box type dryer, a rotary dryer, an air current dryer, a fluidized bed dryer, or a vacuum dryer. Any drying apparatus may be used, but since the nickel ultrafine powder is easily oxidized, it is preferable to perform the treatment in an inert gas or in a vacuum. In addition, when it is desired to control the oxygen amount of the nickel ultrafine powder, a target oxygen amount can be obtained by introducing a gas having a predetermined oxygen partial pressure during drying.

In the nickel ultrafine powder produced by the CVD method, coarse particles having a diameter several times the average particle size exist in a small amount, and reliability is impaired in the MLCC in which the internal electrode is thinned. Therefore, generally, coarse particles are removed by classification treatment. For the classification treatment on an industrial scale, the above-described gravity classifier, cyclone classifier, centrifugal classifier, and the like are used.

In such classification using gravity, when the particle shape is spherical, if classification operation is performed so that the calculated partial classification point (classification point at which coarse powder is 50% and fine powder is 50%) is equivalent to the equal volume sphere equivalent diameter after classification, it is often possible to prevent mixing of coarse particles. In the classification treatment in the present invention, a classification operation is performed as a calculated partial classification point in an apparatus using an intended equal volume sphere equivalent diameter.

However, since the irregularly shaped particles receive a larger resistance from the fluid than the spherical particles, coarse particles are mixed into the fine particle side. Therefore, the connected particles are not removed by classification, and remain on the fine powder side. For this reason, it is important to reduce the number of connected particles in the metal powder before classification.

### EXAMPLES

Hereinafter, the present invention will be specifically described with reference to Examples. However, the present invention is not limited thereto.

### [Method for Producing Metal Powder]

A nickel metal powder as a sample was prepared as follows. In the present example, the apparatus for producing a metal powder of FIG. 1 described above was used.

First, a powder of nickel chloride is introduced into the vaporizing unit 1 maintained at about 1100° C. by nitrogen gas for transportation to obtain nickel chloride vapor. The obtained nickel chloride vapor is introduced into the reaction unit 2 together with an inert gas for transportation, and a reduction reaction is performed at about 1000° C. with hydrogen gas to generate nickel ultrafine powder. The gas amount of the inert gas for transportation was controlled so as to have a target particle size after classification. The hydrogen gas was introduced in an amount of 3.0 times molar amount of nickel chloride so that the reduction reaction proceeded sufficiently. Furthermore, a predetermined amount of sulfurous acid gas was mixed with the inert gas for transportation so as to have a predetermined S (sulfur) content.

The generated nickel ultrafine powder is introduced into the cooling unit 3. The amount of the cooling gas was in a range of 0.0 times molar amount (That is, it corresponds to a case where the cooling gas is not allowed to flow) to 5.0 times molar amount with respect to the total amount of the reaction gas including the inert gas for transportation and the reducing gas.

In addition, in the case of the present invention example, an orifice 7 is provided at the center of the tube in order to prevent flowback of the cooling gas from the cooling unit 3 to the reaction unit 2. An apparatus in which the opening area of the opening 7a at the center of the orifice 7 was changed to 16% to 100% of the cross-sectional area of the reaction unit 2 (that is, corresponding to a case where no orifice is provided) was used. Further, the cylinder 7b as a guide for rectification is provided on the cooling unit 3 side of the opening 7a of the orifice 7. An apparatus was prepared in which the length of the cylinder 7b was 0% to 60% of the diameter of the opening 7a of the orifice 7 (that is, corresponding to a case where no guide is provided).

The cooled nickel ultrafine powder was recovered, washed with pure water, and then dried. In addition, in order to control the amount of oxygen as necessary, an inert gas having a predetermined oxygen partial pressure was introduced into the dryer. Finally, in order to remove coarse particles, the partial classification point was made equal to the target volume cumulative median diameter after classification, and a classification operation was performed by a centrifugal classifier to obtain nickel ultrafine powder.

### [Continuous Operating Time]

The apparatus for producing metal powder to be operated is continuously operated, but when an orifice is provided, adhesion of metal powder may grow and may be blocked. The blockage is defined as a state in which the pressure loss in the downstream of the reaction unit increases and the pressure in the reaction tube increases by 0.1 MPa from the standard internal pressure. The standard internal pressure is a predetermined temperature and a pressure in the reaction tube at the time when a predetermined amount of gas starts to flow, and the continuous operation time is a time (hr) during which the apparatus can be continuously operated without being blocked.

### [Continuous Operability]

The continuous operability is an index on whether industrial production can be performed. A case where the continuous operating time is 24 hr or more was evaluated as A (good), a case where the continuous operating time is 20 hr or more and less than 24 hr was evaluated as B (acceptable), and a case where the continuous operating time is less than 20 hr was evaluated as C (unacceptable).

### [Method for Evaluating Metal Powder]

The obtained nickel ultrafine powder was measured by the following method, and an electrode was produced using the nickel ultrafine powder to prepare an MLCC using the electrode as an internal electrode. The reliability of the MLCC was evaluated.

### [Metal Component]

The metal component was measured by dissolving the metal powder in nitric acid and measuring a liquid sample diluted to a predetermined concentration with an ICP emission spectrophotometer (ICPE-9000 manufactured by SHIMADZU CORPORATION).

### [S (Sulfur) Content]

The S content of the metal powder was measured with a carbon-sulfur analyzer (CS844 manufactured by LECO Japan Corporation).

### [O (Oxygen) Content]

The O content of the metal powder was measured with a gas analyzer in solid (EMGA-900 manufactured by HORIBA, Ltd.).

### [Specific Surface Area]

The specific surface area can be measured by an air permeation method, an adsorption method, an immersion heat method, or the like, but in the present invention, the specific surface area is calculated from the particle size distribution obtained by image analysis because the value fluctuates greatly due to the influence of surface irregularities or the like.

Specifically, a reflected electron image of the metal powder was photographed with a scanning electron microscope (SU5000 manufactured by Hitachi High-Tech Corporation), the image was analyzed with image analysis software (WinRoof manufactured by MITANI CORPORATION), and 8000 or more metal particles were measured and calculated.

Most of the connected particles 10 observed with a scanning electron microscope are spherical or capsule-shaped. As shown in FIG. 2, when the maximum major axis of the connected particle 10 is the major axis (L), it can be well approximated by a sphere with both ends having a minor axis (S) as a diameter and a cylindrical part having a minor axis (S) as a diameter and a length of [major axis (L)−minor axis (S)]. In addition, in the case of major axis=minor axis, the volume of the part of the cylinder becomes 0 and becomes a sphere. For all the metal particles obtained by image analysis, the surface area was integrated from the above-described major axis (L) and minor axis (S), the integrated weight calculated from the density of the metal particles and the shapes of the major axis (L) and minor axis (S) was determined, and the integrated surface area was divided by the integrated weight to obtain the specific surface area. The unit was expressed as m²/g.

### [Particle Size]

A reflected electron image of the metal powder was photographed with a scanning electron microscope (SU5000 manufactured by Hitachi High-Tech Corporation), the image was analyzed with image analysis software (WinRoof manufactured by MITANI CORPORATION), and 8000 or more particles were measured and calculated. In the image analysis, the absolute maximum length, which is the maximum length of the particle, was the major axis (L) of the particle, and the shortest distance between two straight lines when the particle was sandwiched between the two straight lines parallel to the absolute maximum length was the minor axis (S). In addition, in a case where the length measurement is performed in the unit of micron meter (μm), it is preferable that the resolution of the image analysis is performed with accuracy of significant digits of second decimal place or more.

### [Particle Volume]

Most of the connected particles 10 observed with a scanning electron microscope are spherical or capsule-shaped. As shown in FIG. 2, when the maximum major axis of the connected particle 10 is the major axis (L), it can be well approximated by a sphere with both ends having a minor axis (S) as a diameter and a cylindrical part having a minor axis (S) as a diameter and a length of [major axis (L)-minor axis (S)]. In addition, in the case of major axis=minor axis, the volume of the part of the cylinder becomes 0 and becomes a sphere.

### [Volume-Based Median Diameter of Equal Volume Sphere Equivalent Diameter]

The equal volume sphere equivalent diameter (D_{PV}) means a diameter in a case where a spherical particle having the same volume as the metal particle is assumed. For the volume-based median diameter (D_{PV50}), the volume is integrated in the order of volume-based particle sizes to determine a particle size that is 50% of the total particle size.

### [Production and Evaluation of MLCC]

A multilayer ceramic capacitor (MLCC) is prepared by laminating a sheet coated with an internal electrode material on a ceramic green sheet, and press-bonding, cutting, and firing the laminated sheet.

### [Internal Electrode Material]

First, 46 parts by weight of nickel ultrafine powder as an electrode material, 9 parts by weight of a barium titanate powder having a particle size of 50 nm as a sintering suppressing material, 2 parts by weight of an ethyl cellulose resin, and 45 parts by weight of an organic vehicle containing dihydroterpinyl acetate as a component are mixed. Then, a dispersion treatment is performed with a three-roll mill to obtain an internal electrode paste. In the dispersion treatment, the organic vehicle may be reduced as necessary, and about 0.2 parts by weight to 0.7 parts by weight of the polymer dispersion material may be added.

### [Ceramic Green Sheet]

Next, 50 parts by weight of barium titanate having a specific surface area diameter of 200 nm and 26 parts by weight of toluene/ethanol=1/1 as an organic solvent are dispersed with 0.5 parts by weight of a dispersant using a ball mill. Thereafter, 21 parts by weight of a PVB 18% toluene/ethanol solution as an organic binder and 1.5 parts by weight of a plasticizer are added and mixed to obtain a ceramic slurry.

The ceramic slurry is applied onto a polyethylene terephthalate (PET) film by a doctor blade method to obtain a ceramic green sheet having a thickness of 0.5 μm after firing.

### [Capacitor Element Body]

The internal electrode paste is applied onto the ceramic green sheet by screen printing so as to be 1.0 mm×0.5 mm after firing, and an internal electrode layer is formed so that the thickness after firing is 0.5 μm. The ceramic sheet on which the internal electrode layer is printed is peeled off from the PET film, and 100 sheets of this sheet are stacked so as not to be displaced, and then pressure-bonded with a press machine to prepare a ceramic element body. The crimped ceramic element body is cut into a predetermined size with a cutting machine to obtain a capacitor element body.

### [Firing]

The capacitor element body is kept at 260° C. for 6 hours in an air atmosphere to perform binder removal. If necessary, the debinding may be performed while the temperature is maintained at 400° C. for 6 hours in a nitrogen atmosphere. The debound capacitor element body is heated to 1200° C. in a wet nitrogen atmosphere of 2% hydrogen in 4 hours, held at 1200° C. for 2 hours, then lowered to 1000° C. in 1 hour, subjected to a reoxidation treatment in wet nitrogen at 1000° C. for 3 hours, and then cooled to room temperature.

### [Crack Rate]

In the evaluation of the crack rate, 100 samples were observed for the appearance with a digital microscope (VHX-5000 manufactured by KEYENCE CORPORATION) and the inside with an ultrasonic flaw detection imaging detection apparatus (HA-60 A manufactured by Honda Electronics Co., Ltd.), and when a structural defect occurred, it was determined that a crack occurred.

The number of cracks was counted, and when the number of cracks was 0, it was determined as A (good), when the number of cracks was 1, it was determined as B (acceptable), and when the number of cracks was 2 or more, it was determined as C (unacceptable) having a defect in quality.

### [Dielectric Breakdown Voltage]

In addition, in measuring the dielectric breakdown voltage (BDV), Cu electrodes were applied to both end surfaces of the fired capacitor element body to form an external electrode, and a DC-BDV test was performed with a withstand voltage tester (automatic withstand voltage tester 3153 manufactured by HIOKI E.E. CORPORATION). In the test, the pressure rising rate was set to 100 V/sec, the detection current was set to 50 mA, and the DC voltage at which the capacitor element body is short-circuited was set to BDV.

Twenty capacitor element bodies were measured, and when the number of BDVs having an average value of −3σ or less was 0, it was determined as A (good) having a high quality, when the number of BDVs was 1, it was determined as B (acceptable) having an acceptable quality, and when the number of BDVs was 2 or more, it was determined as C (unacceptable) having a defect in quality.

Table 1 shows the results of the production conditions and characterization of the metal powders and the evaluation of the prepared MLCC.

TABLE 1

| | | | | Volume- | | | | | | |
|---|---|---|---|---|---|---|---|---|---|---|
| | | | | based | | | | | | |
| | | | | median | | Rate of | | | | |
| | | | | diameter | | orifice | Rate of | | | |
| | | | Rate of | of equal | Magnification | opening | length of | | | |
| | | | coarse | volume | of cooling | area in | guide | | | |
| | | | connected | sphere | gas amount | cross | cylinder | | | |
| | | | particles in | equivalent | to reaction | sectional | in orifice | | | Specific |
| | | | metal | diameter | gas amount | area of | opening | Continuous | | surface |
| Sample | | Ni metal | particles | DPV50 | (times molar | reaction | diameter | operating | Continuous | area |
| Gr. | No. | (mass %) | (volume %) | (μm) | amount) | unit (%) | (%) | time (hr) | operability | (m²/g) |
| First | 1-1 | 99.9 | 2.3 | 0.21 | 0.5 | 100 | 0 | 24 | A (good) | 2.9 |
| Gr. | 1-2 | 99.9 | 1.2 | 0.22 | 0.5 | 81 | 30 | 24 | A (good) | 2.9 |
| | 1-3 | 99.8 | 0.8 | 0.21 | 0.5 | 75 | 30 | 24 | A (good) | 3.0 |
| | 1-4 | 99.8 | 0.7 | 0.20 | 0.5 | 64 | 30 | 24 | A (good) | 3.1 |
| | 1-5 | 99.9 | 0.7 | 0.20 | 0.5 | 50 | 30 | 24 | A (good) | 3.1 |
| | 1-6 | 99.8 | 0.7 | 0.20 | 0.5 | 36 | 30 | 24 | A (good) | 3.1 |
| | 1-7 | 99.8 | 0.6 | 0.21 | 0.5 | 25 | 30 | 20 | B (acceptable) | 3.0 |
| | 1-8 | 99.9 | 0.7 | 0.19 | 0.5 | 16 | 30 | 3 | C | 3.2 |
| | | | | | | | | | (unacceptable) | |
| | 1-9 | 99.9 | 1.1 | 0.21 | 0.5 | 50 | 0 | 24 | A (good) | 3.0 |
| | 1-10 | 99.9 | 0.8 | 0.21 | 0.5 | 50 | 10 | 24 | A (good) | 3.0 |
| | 1-11 | 99.9 | 0.7 | 0.20 | 0.5 | 50 | 60 | 13 | C | 3.1 |
| | | | | | | | | | (unacceptable) | |
| Second | 2-1 | 98.6 | 0.6 | 0.20 | 1.0 | 50 | 30 | 24 | A (good) | 3.1 |
| Gr. | 2-2 | 99.3 | 0.6 | 0.21 | 1.0 | 50 | 30 | 24 | A (good) | 3.0 |
| Third | 3-1 | 99.9 | 1.5 | 0.22 | 0.0 | 50 | 30 | 24 | A (good) | 2.9 |
| Gr. | 3-2 | 99.9 | 1.2 | 0.21 | 0.3 | 50 | 30 | 24 | A (good) | 3.0 |
| | 3-3 | 99.9 | 0.7 | 0.20 | 0.5 | 50 | 30 | 24 | A (good) | 3.1 |
| | 3-4 | 99.8 | 0.6 | 0.20 | 1.0 | 50 | 30 | 24 | A (good) | 3.2 |
| | 3-5 | 99.9 | 0.5 | 0.20 | 2.0 | 50 | 30 | 24 | A (good) | 3.0 |
| | 3-6 | 99.9 | 0.5 | 0.20 | 3.0 | 50 | 30 | 24 | A (good) | 3.1 |
| | 3-7 | 99.9 | 0.4 | 0.21 | 4.0 | 50 | 30 | 24 | A (good) | 3.0 |
| | 3-8 | 99.9 | 0.3 | 0.20 | 5.0 | 50 | 30 | 24 | A (good) | 3.1 |
| | 3-9 | 99.9 | 0.3 | 0.21 | 6.0 | 50 | 30 | 12 | C | 3.0 |
| | | | | | | | | | (unacceptable) | |
| Fourth | 4-1 | 99.8 | 1.2 | 0.07 | 0.5 | 50 | 30 | 24 | A (good) | 7.6 |
| Gr. | 4-2 | 99.9 | 1.0 | 0.09 | 0.5 | 50 | 30 | 24 | A (good) | 6.4 |
| | 4-3 | 99.9 | 0.8 | 0.15 | 0.5 | 50 | 30 | 24 | A (good) | 4.1 |
| | 4-4 | 99.9 | 0.6 | 0.26 | 0.5 | 50 | 30 | 24 | A (good) | 2.4 |
| | 4-5 | 99.9 | 0.5 | 0.34 | 0.5 | 50 | 30 | 24 | A (good) | 1.9 |
| | 4-6 | 99.9 | 0.5 | 0.37 | 0.5 | 50 | 30 | 24 | A (good) | 1.7 |
| Fifth | 5-1 | 99.9 | 0.7 | 0.17 | 1.0 | 50 | 30 | 24 | A (good) | 3.6 |
| Gr. | 5-2 | 99.8 | 0.6 | 0.17 | 1.0 | 50 | 30 | 24 | A (good) | 3.6 |
| | 5-3 | 99.9 | 0.6 | 0.16 | 1.0 | 50 | 30 | 24 | A (good) | 3.7 |
| | 5-4 | 99.6 | 0.5 | 0.17 | 1.0 | 50 | 30 | 24 | A (good) | 3.6 |
| | 5-5 | 99.8 | 0.6 | 0.17 | 1.0 | 50 | 30 | 24 | A (good) | 3.6 |
| | 5-6 | 99.9 | 0.6 | 0.17 | 1.0 | 50 | 30 | 24 | A (good) | 3.5 |
| | 5-7 | 99.9 | 0.6 | 0.17 | 1.0 | 50 | 30 | 24 | A (good) | 3.6 |
| Sixth | 6-1 | 99.9 | 0.7 | 0.20 | 1.0 | 50 | 30 | 24 | A (good) | 3.1 |
| Gr. | 6-2 | 99.8 | 0.5 | 0.21 | 1.0 | 50 | 30 | 24 | A (good) | 3.0 |
| | 6-3 | 99.8 | 0.6 | 0.20 | 1.0 | 50 | 30 | 24 | A (good) | 3.1 |
| | 6-4 | 99.9 | 0.5 | 0.21 | 1.0 | 50 | 30 | 24 | A (good) | 3.0 |
| | 6-5 | 99.9 | 0.4 | 0.22 | 1.0 | 50 | 30 | 24 | A (good) | 2.9 |
| | 6-6 | 99.8 | 0.5 | 0.21 | 1.0 | 50 | 30 | 24 | A (good) | 3.0 |
| | 6-7 | 99.9 | 0.5 | 0.21 | 1.0 | 50 | 30 | 24 | A (good) | 3.0 |

| | | | | | | NG | | |
|---|---|---|---|---|---|---|---|---|
| | | | | Number | | number of | | |
| | | | | of | | breakdown | Breakdown | |
| Sample | | S content | O content | cracks | Crack rate | voltage | voltage | |
| Gr. | No. | (ppm/(m²/g)) | (ppm/(m²/g)) | (pieces) | determination | (pieces) | determination | Note |
| First | 1-1 | 410 | 3800 | 5 | C | 12 | C | Comparative example |
| Gr. | | | | | (unacceptable) | | (unacceptable) | |
| | 1-2 | 420 | 3900 | 3 | C | 4 | C | Comparative example |
| | | | | | (unacceptable) | | (unacceptable) | |
| | 1-3 | 400 | 3700 | 0 | A (good) | 0 | A (good) | Present invention |
| | | | | | | | | example |
| | 1-4 | 380 | 3500 | 0 | A (good) | 0 | A (good) | Present invention |
| | | | | | | | | example |
| | 1-5 | 390 | 3500 | 0 | A (good) | 0 | A (good) | Present invention |
| | | | | | | | | example |
| | 1-6 | 390 | 3600 | 0 | A (good) | 0 | A (good) | Present invention |
| | | | | | | | | example |
| | 1-7 | 400 | 4000 | 0 | A (good) | 0 | A (good) | Present invention |
| | | | | | | | | example |
| | 1-8 | 370 | 3400 | 0 | A (good) | 0 | A (good) | Present invention |
| | | | | | | | | example |
| | 1-9 | 400 | 3700 | 2 | C | 2 | C | Comparative example |
| | | | | | (unacceptable) | | (unacceptable) | |
| | 1-10 | 400 | 4000 | 0 | A (good) | 0 | A (good) | Present invention |
| | | | | | | | | example |
| | 1-11 | 380 | 3500 | 0 | A (good) | 0 | A (good) | Present invention |
| | | | | | | | | example |
| Second | 2-1 | 490 | 4400 | 3 | C | 1 | B (acceptable) | Comparative example |
| Gr. | | | | | (unacceptable) | | | |
| | 2-2 | 500 | 4500 | 2 | C | 1 | B (acceptable) | Comparative example |
| | | | | | (unacceptable) | | | |
| Third | 3-1 | 450 | 4200 | 4 | C | 8 | C | Comparative example |
| Gr. | | | | | (unacceptable) | | (unacceptable) | |
| | 3-2 | 440 | 4000 | 2 | C | 5 | C | Comparative example |
| | | | | | (unacceptable) | | (unacceptable) | |
| | 3-3 | 420 | 3900 | 0 | A (good) | 0 | A (good) | Present invention |
| | | | | | | | | example |
| | 3-4 | 440 | 3800 | 0 | A (good) | 0 | A (good) | Present invention |
| | | | | | | | | example |
| | 3-5 | 430 | 4000 | 0 | A (good) | 0 | A (good) | Present invention |
| | | | | | | | | example |
| | 3-6 | 420 | 3800 | 0 | A (good) | 0 | A (good) | Present invention |
| | | | | | | | | example |
| | 3-7 | 430 | 4000 | 0 | A (good) | 0 | A (good) | Present invention |
| | | | | | | | | example |
| | 3-8 | 430 | 3900 | 0 | A (good) | 0 | A (good) | Present invention |
| | | | | | | | | example |
| | 3-9 | 440 | 4000 | 0 | A (good) | 0 | A (good) | Present invention |
| | | | | | | | | example |
| Fourth | 4-1 | 290 | 2900 | 3 | C | 1 | B (acceptable) | Comparative example |
| Gr. | | | | | (unacceptable) | | | |
| | 4-2 | 280 | 3000 | 0 | A (good) | 1 | B (acceptable) | Present invention |
| | | | | | | | | example |
| | 4-3 | 340 | 3000 | 0 | A (good) | 0 | A (good) | Present invention |
| | | | | | | | | example |
| | 4-4 | 370 | 3700 | 0 | A (good) | 0 | A (good) | Present invention |
| | | | | | | | | example |
| | 4-5 | 430 | 3700 | 0 | A (good) | 0 | A (good) | Present invention |
| | | | | | | | | example |
| | 4-6 | 400 | 4000 | 0 | A (good) | 3 | C | Comparative example |
| | | | | | | | (unacceptable) | |
| Fifth | 5-1 | 60 | 3900 | 1 | B (acceptable) | 1 | B (acceptable) | Present invention |
| Gr. | | | | | | | | example |
| | 5-2 | 80 | 3600 | 0 | A (good) | 0 | A (good) | Present invention |
| | | | | | | | | example |
| | 5-3 | 220 | 3500 | 0 | A (good) | 0 | A (good) | Present invention |
| | | | | | | | | example |
| | 5-4 | 460 | 3700 | 0 | A (good) | 0 | A (good) | Present invention |
| | | | | | | | | example |
| | 5-5 | 580 | 3600 | 0 | A (good) | 0 | A (good) | Present invention |
| | | | | | | | | example |
| | 5-6 | 740 | 3700 | 1 | B (acceptable) | 0 | A (good) | Present invention |
| | | | | | | | | example |
| | 5-7 | 860 | 3600 | 1 | B (acceptable) | 1 | B (acceptable) | Present invention |
| | | | | | | | | example |
| Sixth | 6-1 | 510 | 1000 | 1 | B (acceptable) | 1 | B (acceptable) | Present invention |
| Gr. | | | | | | | | example |
| | 6-2 | 470 | 1300 | 0 | A (good) | 0 | A (good) | Present invention |
| | | | | | | | | example |
| | 6-3 | 520 | 3500 | 0 | A (good) | 0 | A (good) | Present invention |
| | | | | | | | | example |
| | 6-4 | 470 | 5700 | 0 | A (good) | 0 | A (good) | Present invention |
| | | | | | | | | example |
| | 6-5 | 520 | 7000 | 0 | A (good) | 0 | A (good) | Present invention |
| | | | | | | | | example |
| | 6-6 | 500 | 7700 | 1 | B (acceptable) | 1 | B (acceptable) | Present invention |
| | | | | | | | | example |
| | 6-7 | 510 | 9100 | 1 | B (acceptable) | 1 | B (acceptable) | Present invention |
| | | | | | | | | example |

The nickel ultrafine powder according to the present invention example exhibited excellent effects on both the crack rate and the dielectric breakdown voltage, which are reliability evaluation of the MLCC prepared based on the nickel ultrafine powder.

On the other hand, in comparative examples outside the scope of the present invention, there were many cracks occurred, the dielectric breakdown voltage was at a low level, and the reliability was impaired.

Specifically, the samples in Table 1 were sorted into six groups.

The first Gr is an example changed with respect to a mechanism (orifice related) for preventing the flowback of the cooling gas in the production method of the present invention. In the case where there was no orifice mechanism (sample No. 1-1), in the case where the orifice opening area was large (sample No. 1-2), and in the case where there was no guide cylinder (sample Nos. 1-1 and 1-9), the flowback of the cooling gas occurred, and thus the rate of the capsule-shaped coarse connected particles increased. Therefore, cracks were occurred, and the NG number of the breakdown voltage was poor.

The second Gr is a comparative example in which the purity of nickel is reduced for convenience by mixing a predetermined amount of iron chloride with nickel chloride as a raw material and reacting the mixture, and the nickel metal component is out of the scope of the present invention. In this case, the occurrence of cracks increased.

The third Gr is a sample group in which the rate of the capsule-shaped coarse connected particles in the metal particles is changed by increasing or decreasing the amount of inert gas for cooling. In comparative examples (sample Nos. 3-1 and 3-2) in which the rate was out of the range of the present invention, there were many cracks occurred, and the dielectric breakdown voltage was at a low level. In addition, in a case where the magnification of the cooling gas amount is too large (sample No. 3-9), the quality of the metal particles is sufficient, but the continuous productivity, which is an index of whether industrial production is possible, is not sufficient.

The fourth Gr is a sample group in which the D_{PV50} of the particle size is changed by increasing or decreasing the amount of inert gas for transportation. In comparative example (sample No. 4-1) in which the value was out of the range of the present invention, there were many cracks occurred, and in comparative example (sample No. 4-6), the dielectric breakdown voltage was also at a low level.

The fifth Gr is a sample group in which the S (sulfur) content is changed by increasing or decreasing the sulfite gas to be mixed with the inert gas for transportation. In the present invention example (sample Nos. 5-1, 5-6, 5-7) out of the scope of the invention according to claim 2, the crack rate and the NG number of the dielectric breakdown voltage were slightly poor.

The sixth Gr is a sample group in which the O (oxygen) content is changed by increasing or decreasing the oxygen partial pressure in the dryer. In the present invention examples (sample Nos. 6-1, 6-6, 6-7) out of the scope of the invention according to claim 3, the crack rate and the NG number of the dielectric breakdown voltage were slightly poor.

### REFERENCE SIGNS LIST

1 Vaporizing unit
2 Reaction unit
3 Cooling unit
4 Raw material introduction pipe
5 Introduction pipe
6 Hydrogen nozzle
7 Orifice
7a Orifice opening
7b Cylinder of guide of orifice
8 Cooling gas nozzle
9 Exhaust pipe
10 Connected particle
L Major axis
S Minor axis

1. A metal powder in which 99.5% or more of a metal component is nickel on a mass basis, and the balance is an inevitable impurity, wherein
when a maximum major axis of a metal particle constituting the metal powder is a major axis (L) and a diagonal width of the major axis (L) is a minor axis (S), a ratio of metal particles having a ratio (S/D_{PV}) of the minor axis (S) to an equal volume sphere equivalent diameter (D_{PV}) of the metal particles of 0.92 or less and a ratio (D_{PV}/D_{PV50}) of the equal volume sphere equivalent diameter (D_{PV}) to a volume-based median diameter (D_{PV50}) of 1.8 or more is 1.0% or less on a volume basis, and
the volume-based median diameter (D_{PV50}) of the metal particle is 0.08 μm to 0.35 μm.

2. The metal powder according to claim 1, wherein the S (sulfur) content of the metal powder per specific surface area of 1 m²/g is 70 ppm to 600 ppm.

3. The metal powder according to claim 1, wherein an O (oxygen) content per a specific surface area of 1 m²/g of the metal powder is 1200 ppm to 7000 ppm.

4. A method for producing a metal powder,
comprising:
a vaporization step of evaporating or vaporizing a metal compound to form a metal compound gas;
a reaction step of reacting the metal compound gas with a reducing gas to produce metal powder; and
a cooling step of cooling a generated metal powder,
wherein a gas cooled in the cooling step is prevented from flowing back to the reaction step, and
in the cooling step, a gas for cooling in an amount of 0.5 times molar amount to 5.0 times molar amount of a total amount of an inert gas and the reducing gas required for the reaction is used.

5. The method for producing a metal powder according to claim 4, wherein
the metal powder contains nickel as 99.5% or more of a metal component on a mass basis and an inevitable impurity as a balance, and
when a maximum major axis of a metal particle constituting the metal powder is a major axis (L) and a diagonal width of the major axis (L) is a minor axis (S), a ratio of metal particles having a ratio (S/D_{PV}) of the minor axis (S) to an equal volume sphere equivalent diameter (D_{PV}) of the metal particles of 0.92 or less and a ratio (D_{PV}/D_{PV50}) of the equal volume sphere equivalent diameter (D_{PV}) to a volume-based median diameter (D_{PV50}) of 1.8 or more is 1.0% or less on a volume basis, and
the volume-based median diameter (D_{PV50}) of the metal particle is 0.08 μm to 0.35 μm.

6. The method for producing a metal powder according to claim 5, wherein the S (sulfur) content of the metal powder per specific surface area of 1 m²/g is 70 ppm to 600 ppm.

7. The method for producing a metal powder according to claim 5, wherein an O (oxygen) content per a specific surface area of 1 m²/g of the metal powder is 1200 ppm to 7000 ppm.

8. The metal powder according to claim 2, wherein an O (oxygen) content per a specific surface area of 1 m²/g of the metal powder is 1200 ppm to 7000 ppm.

9. The method for producing a metal powder according to claim 6, wherein an O (oxygen) content per a specific surface area of 1 m²/g of the metal powder is 1200 ppm to 7000 ppm.
